(19) United States
(12) Patent Application Publication
(10) Pub. No.: US 2010/0306121 A1
(43) Pub. Date: Dec. 2, 2010

(54) SELLING AND DELIVERING REAL GOODS AND SERVICES WITHIN A VIRTUAL REALITY WORLD

(76) Inventor: Yunus Ciptawilangga, Bandung (ID)

Correspondence Address: Vern Maine & Associates, 547 AMHERST STREET, 3RD FLOOR, NASHUA, NH, 03063-4000, US

(21) Appl. No.: 12/474,206

(22) Filed: May 28, 2009

(51) Int. Cl. G06Q 30/00; G06Q 10/00

(52) U.S. Cl. 705/319; 705/27; 715/850; 705/1.1

(57) ABSTRACT

An ecommerce system is claimed that enables users to purchase real-world consumables within a virtual reality world, and then to immediately receive and consume the real-world consumables without leaving the virtual reality world. Users purchase and consume consumables such as movies, TV shows, lectures, books, magazines, consultations with advisors, psychic readings, and horoscopes, by controlling actions of avatars within the virtual world. In some embodiments, an avatar can earn virtual money by purchasing real-world consumables, and can use the virtual money to purchase additional real and/or virtual consumables. In other embodiments, avatars can earn virtual and/or real money by working in the virtual reality world. In various embodiments avatars can gain status, and can receive rewards based on status, such as access to special locations in the virtual world. And in some embodiments, avatars can compete with each other based on relative wealth, virtual possessions, and/or status.

### FIELD OF THE INVENTION

The invention generally relates to online ecommerce systems, and more specifically to ecommerce systems that are implemented in a virtual reality world.

### BACKGROUND OF THE INVENTION

Internet-accessible “virtual reality worlds” have become increasingly popular as personal computers have grown in power and become widely affordable, and as high-speed internet access has become commonplace. A virtual reality world can provide to an internet user an illusion of interacting with, and generally existing in a realistic, computer-generated world that includes a plurality of virtual locations to be visited and explored. Internet-accessible virtual reality worlds are typically hosted by one or more internet servers, and can be accessed over the internet using almost any internet-capable device, such as a personal computer or a portable, hand-held internet-capable device.

Typically, a user interacts with a virtual reality world by controlling the actions of a virtual person, or “avatar,” that is able to travel from one virtual location to another to enter and explore virtual locations as directed by the user. In many virtual reality worlds, avatars are able to represent the actions of real people in many ways, such as by looking in different directions, moving to different locations, entering buildings, handling objects, and even interacting with other avatars. Interactions between avatars can include speaking, showing facial expressions, and using movements to display a range of feelings and emotions, for example by drooping over to indicate illness, shedding tears to show sadness, or jumping around to show joy or excitement.

Electronic advertising and ecommerce are known to be included in some virtual reality worlds, whereby avatars are able to view and/or listen to advertisements, view and/or handle items for sale, and even complete purchase transactions for selected items, which are then shipped in the real world to the controller of the avatar. Some virtual reality worlds provide virtual retail locations, where an avatar controlled by a consumer can interact with an avatar controlled by a vendor, thereby representing an interaction between a customer and a retail salesperson. The two avatars can exchange information regarding products for sale, consider options, and complete an actual purchase transaction.

However, these methods of ecommerce include a time delay while waiting for delivery of a purchase to a consumer, and this delay can frustrate a consumer's desire to immediately enjoy a purchased good or service. Also, since a consumer must leave the virtual reality world so as to receive and use a purchased good or service, the delivery of an ecommerce purchase can reduce and/or interrupt a consumer's online shopping time.

### SUMMARY OF THE INVENTION

An electronic commerce (“ecommerce”) system is claimed that enables a user to purchase a real-world good or service within a virtual reality world, and then to immediately receive and consume the real-world good or service within the virtual reality world, without any need to wait for delivery, and without any need to leave the virtual reality world.

By delivering the good or service, such as a movie, a lecture, the text of a book or magazine, a personal consultation, or a psychic reading, within the virtual reality world, the desire of the consumer is instantly satisfied, and the consumer is thereafter more likely to remain in the virtual reality world and continue shopping. Also, delivery of real good or services within the virtual reality world tends to increase the enjoyment and realism of the virtual reality world, thereby tending to increase the time spent shopping in the virtual reality world.

The user purchases and consumes the good or service by controlling the actions of an avatar so as to travel to and enter a virtual location within the virtual world where the good or service is offered for sale and/or delivered. In some embodiments, purchasing and consuming real-world goods and services causes an avatar to earn virtual money or credit that can be used to purchase additional real or virtual goods and services. In other embodiments, avatars can work in the virtual reality world so as to earn virtual and/or real money and/or credit. In various embodiments avatars can also earn virtual status, and can receive rewards based on their virtual status, such as access to special locations in the virtual world. And in certain embodiments, avatars can compete with each other based on relative wealth, virtual possessions, and/or virtual status.

The present invention is an ecommerce system that includes media containing software that is operable on a computer and accessible to a user. The software is able to create and present to the user a virtual reality world that includes at least one offer for sale of a consumable, the consumable being one of a real good and a real service that can be consumed within the virtual reality world, and a virtual consumer that is controllable by the user so as to purchase the consumable and consume it within the virtual reality world. In preferred embodiments, the software is accessible to the user over at a network and/or the internet.

In various preferred embodiments, the consumable is at least one of a television show, a movie, a play, a musical performance, a lecture, a book, a magazine, a consultation with an advising person, a consultation with a medical expert, a consultation with a legal expert, a horoscope, and a psychic reading.

In some preferred embodiments the virtual reality world further includes a virtual sales enabler that is able interact with the virtual consumer so as to facilitate the purchase of the consumable. In some of these embodiments, the virtual sales enabler is controllable by the software and/or by a real representative of a real place of business.

In preferred embodiments, the virtual reality world enables a competition between the user and a plurality of virtual competitors. In some of these embodiments, at least one of the plurality of virtual competitors is controlled by a competing user. And in other of these embodiments, at least one of the plurality of virtual competitors is controlled automatically by the software.

In various preferred embodiments, the virtual consumer is able to obtain virtual social status in the virtual reality world. In some of these embodiments, the attainment of virtual social status can be accomplished by one or more of the following:

accumulating virtual money that is usable in the virtual reality world;

acquiring products through making purchases in the virtual reality world;

developing a talent in the virtual reality world; and

enhancing a personal image in the virtual reality world.

In other of these preferred embodiments, a reward can be earned by the virtual consumer due to attainment of a specified level of virtual social status. And in some of these embodiments the reward is one of the following:

allowing the virtual consumer to visit a status location within the virtual reality world;

providing a status email address for the user;

providing a status membership card to the user; and

awarding a prize to the user.

In preferred embodiments, the user is able to control the virtual consumer so as to earn virtual money for use in purchasing consumables in the virtual reality world. In some preferred embodiments the user is able to earn virtual money for use in purchasing consumables in the virtual reality world by using real money to purchase a consumable in the virtual reality world.

In various preferred embodiments the virtual reality world includes at least one virtual city that corresponds to a real-world city. And in certain preferred embodiments the virtual consumer is able to interact socially within the virtual reality world, the social interaction being with other virtual consumers controlled by other users.

### BRIEF DESCRIPTION OF THE DRAWINGS

The invention will be more fully understood by reference to the detailed description, in conjunction with the following figures, wherein:

FIG. 1 is a perspective drawing that illustrates a user causing an avatar to purchase a movie ticket in a virtual reality world of the present invention;

FIG. 2 is a perspective drawing that illustrates the avatar of FIG. 1 watching the movie, thereby delivering the purchased good or service to the user within the virtual reality world;

FIG. 3 is a perspective drawing that illustrates the avatar of FIG. 1 listening to a lecture delivered by a product delivery avatar within the virtual reality world; and

FIG. 4 is a perspective drawing that illustrates the avatar of FIG. 1 receiving a horoscope reading from a product delivery avatar within the virtual reality world.

### DETAILED DESCRIPTION OF PREFERRED EMBODIMENTS

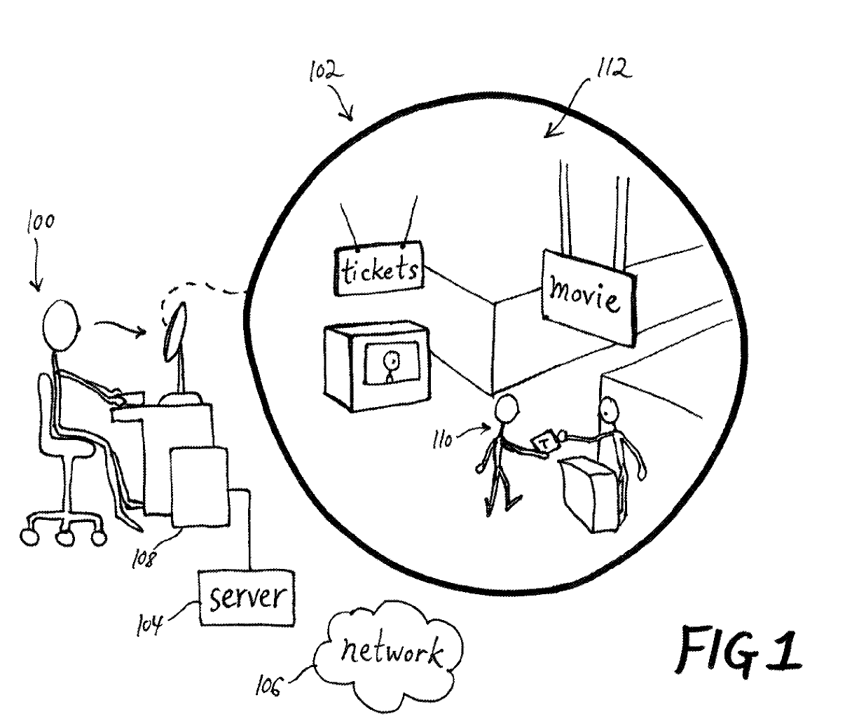

With reference to FIG. 1, the present invention is an ecommerce system that enables a user 100 to both purchase and consume a consumable within a virtual reality world 102, where the consumable is either a good or a service. In preferred embodiments, the user 100 is able to access the virtual reality world 102 by connecting to a server 104 over a network or the internet 106. In FIG. 1, the user 100 is illustrated as accessing the network using a personal computer 108.

The user is able to control the actions of a virtual consumer 110, or “avatar” 110 so as to travel to any of a plurality of virtual locations included within the virtual world, and purchase and consume goods and services that are accessible at the virtual locations. For example, in FIG. 1 the avatar 110 is has been directed to a virtual location that represents a space immediately in front of a virtual movie theater. The avatar 110 is illustrated in FIG. 1 as purchasing a ticket to a movie from a software-controlled virtual sales enabler 112, which in FIG. 1 is a simulated movie ticket salesperson. In some embodiments, a second avatar controlled by a second user can “work” as a sales enabler, and can thereby earn virtual and/or real money to be used to make purchases.

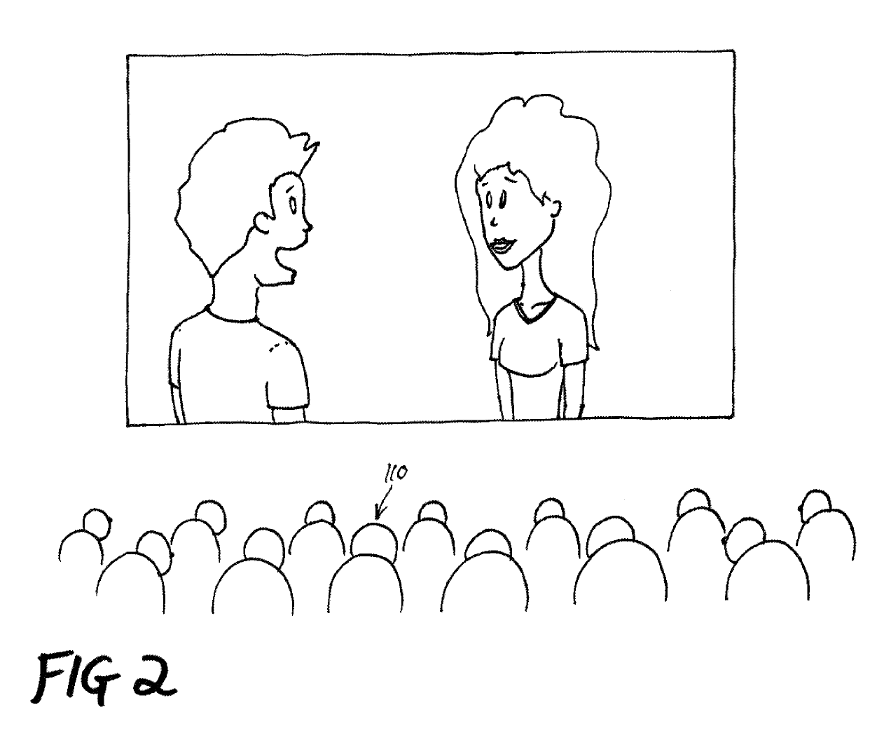

As is illustrated in FIG. 2, once the avatar 110 has purchased the ticket, the avatar 110 can be directed to move into the virtual interior of the movie theater, and to take a seat together with other avatars, at which point the movie is displayed to the avatar 110, and hence to the user 100. The user 100 is able to watch the movie on the screen of the computer 108, and is thereby able to “consume” the “consumable” (i.e. watch the movie) that was purchased, without leaving the virtual reality world.

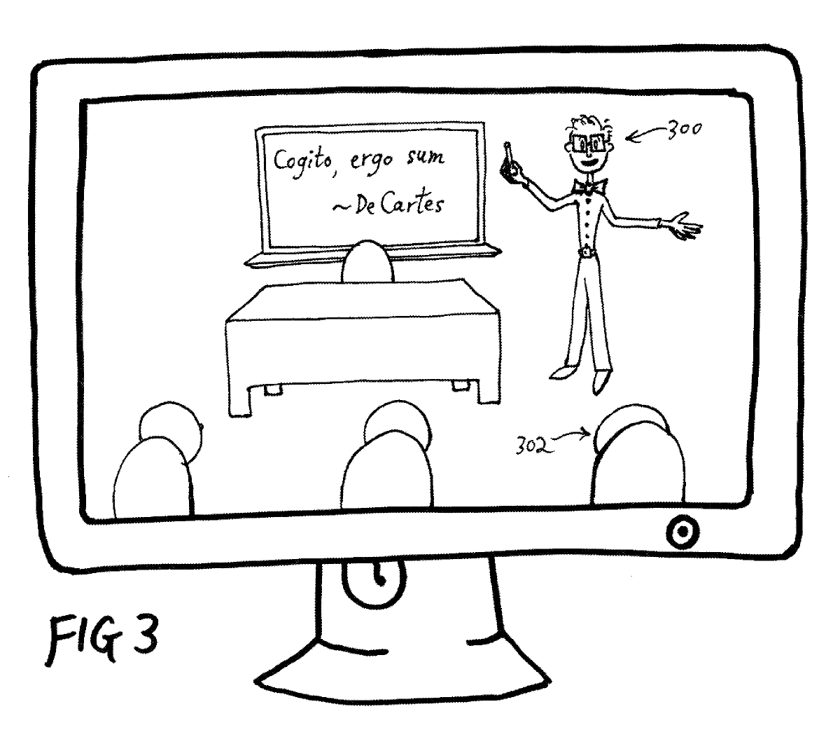

FIG. 3 is an illustration of another virtual location that is included within the virtual reality world of FIG. 1. In the virtual location of FIG. 3, a lecture is being delivered by a virtual lecturer 300 to a group of avatars 302, and thereby to the users of the avatars. In this virtual location, the consumable that is delivered is the lecture, for example as part of an online educational course. The virtual lecturer 300 can be software controlled, or it can be an avatar that is controlled by a real lecturer in the real world. In the latter case, the virtual lecturer 300 can respond to questions posed by the users through their avatars 302.

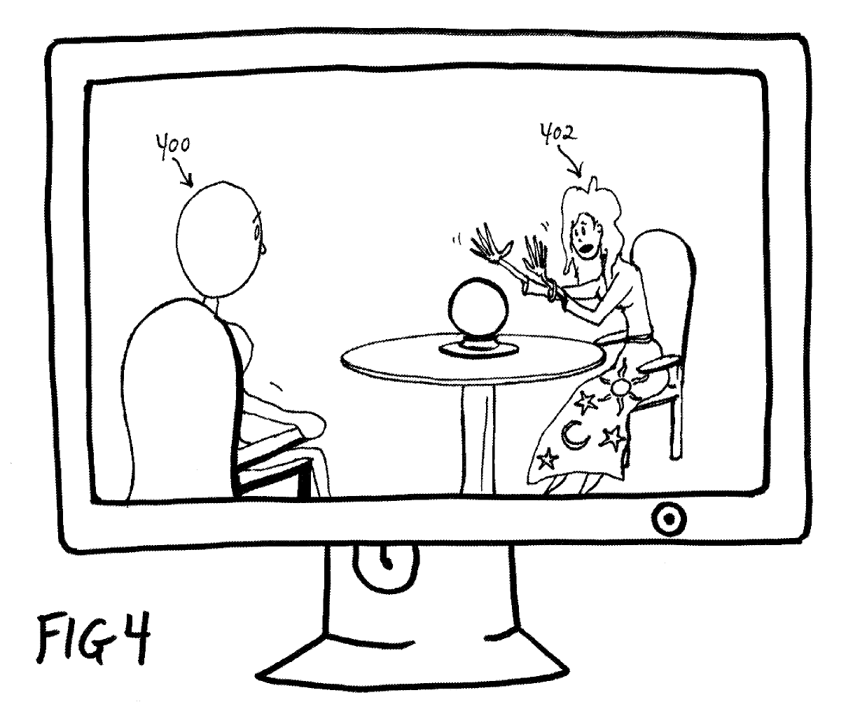

FIG. 4 illustrates yet another virtual location included within the virtual reality world of FIG. 1, in which a psychic reading or horoscope is being provided to an avatar 400, and hence to the user of the avatar, by a virtual psychic 402. The virtual psychic 402 can be software controlled, or it can be a second avatar controlled by a real psychic in the real world. In the latter case, the virtual psychic 402 can respond to specific questions about the future posed by the user through his or her avatar 400.

Other modifications and implementations will occur to those skilled in the art without departing from the spirit and the scope of the invention as claimed. Accordingly, the above description is not intended to limit the invention except as indicated in the following claims.

What is claimed is:

1. An ecommerce system, comprising:
media containing software that is operable on a computer and accessible to a user, the software being able to create and present to the user a virtual reality world, the virtual reality world including:
at least one offer for sale of a consumable, the consumable being one of a real good and a real service that can be consumed within the virtual reality world; and
a virtual consumer that is controllable by the user so as to purchase the consumable and consume it within the virtual reality world.

2. The system of claim 1, wherein the software is accessible to the user over at least one of:
a network; and
the internet.

3. The system of claim 1, wherein the consumable is at least one of:
a television show;
a movie;
a play;
a musical performance;
a lecture;
a book;
a magazine;
a consultation with an advising person;
a consultation with a medical expert;
a consultation with a legal expert;
a horoscope; and
a psychic reading.

4. The system of claim 1, wherein the virtual reality world further includes a virtual sales enabler that is able interact with the virtual consumer so as to facilitate the purchase of the consumable.

5. The system of claim 6, wherein the virtual sales enabler is controllable by at least one of:
the software; and
a real representative of a real place of business.

6. The system of claim 1, wherein the virtual reality world enables a competition between the user and a plurality of virtual competitors.

7. The system of claim 6, wherein at least one of the plurality of virtual competitors is controlled by a competing user.

8. The system of claim 6, wherein at least one of the plurality of virtual competitors is controlled automatically by the software.

9. The system of claim 1, wherein the virtual consumer is able to obtain virtual social status in the virtual reality world.

10. The system of claim 9, wherein the attainment of virtual social status can be accomplished by at least one of:
accumulating virtual money that is usable in the virtual reality world;
acquiring products through making purchases in the virtual reality world;
developing a talent in the virtual reality world; and
enhancing a personal image in the virtual reality world.

11. The system of claim 9, wherein a reward can be earned by the virtual consumer due to attainment of a specified level of virtual social status.

12. The system of claim 11, wherein the reward is at least one of:
allowing the virtual consumer to visit a status location within the virtual reality world;
providing a status email address for the user;
providing a status membership card to the user; and
awarding a prize to the user.

13. The system of claim 1, wherein the user is able to control the virtual consumer so as to earn virtual money for use in purchasing consumables in the virtual reality world.

14. The system of claim 1, wherein the user is able to earn virtual money for use in purchasing consumables in the virtual reality world by using real money to purchase a consumable in the virtual reality world.

15. The system of claim 1, wherein the virtual reality world includes at least one virtual city that corresponds to a real-world city.

16. The system of claim 1, wherein the virtual consumer is able to interact socially within the virtual reality world, the social interaction being with other virtual consumers controlled by other users.
